(19) United States
(12) Patent Application Publication
(10) Pub. No.: US 2005/0259829 A1
(43) Pub. Date: Nov. 24, 2005

(54) Stand-alone microphone test system for a hearing device

(75) Inventors: Koen Van den Heuvel, Hove (BE); Michael Goorevich, Dulwich Hill (AU)

Correspondence Address: JAGTIANI + GUTTAG, 10363-A DEMOCRACY LANE, FAIRFAX, VA, 22030, US

(73) Assignee: Cochlear Limited, Lane Cove (AU)

(21) Appl. No.: 11/135,524

(22) Filed: May 24, 2005

Related U.S. Application Data
(60) Provisional application No. 60/573,419, filed on May 24, 2004.

(51) Int. Cl. H04R 29/00

(52) U.S. Cl. 381/60

(57) ABSTRACT

The present invention provides a stand-alone microphone test system for a hearing device, comprising a hearing device having at least one microphone, a sound source in communication with the hearing device, wherein, when in operation, the sound source receives a signal from the hearing device, and a mold oriented to hold the hearing device and the sound source such that output from the sound source may be directed to the at least one microphone. There is also provided a stand-alone microphone test method for a hearing device, comprising providing a test signal/sequence output to a sound source/receiver, providing a reference signal to a comparator, receiving output from the Sound source/receiver in a microphone, transmitting the received signal to the comparator, comparing the received signal with the reference signal, and providing a test result.

### BACKGROUND

1. Field of the Invention

The present invention relates generally to stand-alone microphone test devices and systems for hearing aids and hearing prostheses, and to a testing method for microphones in such devices.

2. Related Art

A prosthetic hearing device or hearing aid is used to aid patients who have a hearing deficiency. Microphone quality greatly influences a patient's satisfaction and ability to discern sound. The available methods and apparatus used to test the quality of the microphone are inadequate, expensive, and/or prone to error or uncertainty.

Microphones degrade in two primary ways. First, a microphone may degrade due to natural degradation over time. Second, a microphone may degrade by a significant and/or sudden failure, not caused by natural degradation.

One typical measurement technique for measuring the frequency response of a microphone is the speech and/or sound perception of the user. This requires time and effort as a complete speech test should be conducted in a reproducible environment. Typically, an effective technical measurement technique for measuring the frequency response of a microphone is to utilize specialized and expensive analysis equipment. For example, some systems require that the hearing device be connected to an auxiliary computer to conduct a test.

The object of the present invention is to provide a stand alone microphone test system that does not require elaborate, complex equipment, and may be used by the hearing device recipient.

### SUMMARY

According to one aspect of the present invention, there is provided a stand-alone microphone test device for a hearing device, said device including a housing adapted to receive a hearing device having at least one microphone, and a sound source operatively adapted to communicate with the hearing device, said housing operatively maintaining the sound source and said or each microphone in a predetermined relationship, so that operatively, when the sound source receives a test signal from the hearing device, it produces an acoustic signal which is received by said or each microphone.

According to a second aspect of the present invention, there is provided a stand-alone microphone test system for a hearing device, said test system including a test device having a housing adapted to receive a hearing device having at least one microphone, and a sound source operatively adapted to communicate with the hearing device, said housing operatively maintaining the sound source and said or each microphone in a predetermined relationship, said hearing device further including a comparator and means for generating a test signal for transmission to said sound source, so that operatively, when the sound source receives a test signal from the hearing device, it produces an acoustic signal which is received by said or each microphone, said microphone detecting said signal and communicating a corresponding received signal to said comparator, said hearing device further sending a reference signal to said comparator, so that said received signal and said reference signal can be compared to determine the quality of the or each microphone.

The test system may further include a reference signal being sent to a comparator, which then compares the reference signal with the signal transmitted by the microphone to determine the quality of the microphone.

According to another aspect of the present invention, there is provided a microphone test method for a hearing device, including the steps of:
providing a housing adapted to receive a hearing device having at least one microphone, and a sound source operatively adapted to communicate with the hearing device;
Placing said hearing device into said housing;
Placing said hearing device into communication with said sound source
Generating a test signal in said hearing device and communicating said signal to said sound source, so that said sound source generates an acoustic signal;
receiving said acoustic signal from the sound source using said or each microphone,
processing the received acoustic signal to determine the quality of the or each microphone.

It will be understood that the present invention is applicable to any hearing device which is reliant upon microphone quality, for example hearing aids, or hearing implants.

### BRIEF DESCRIPTION OF THE DRAWINGS

The invention will be described in conjunction with the accompanying drawings, in which:

FIG. 1 shows a schematic view of a hearing device configured for a stand-alone microphone test in accordance with an embodiment of the present invention;

FIG. 2 shows a schematic view of a hearing device configured for a stand-alone microphone test in accordance with an embodiment of the present invention;

FIG. 3 shows a prior art method of testing a hearing device; and

FIG. 4 shows a method of testing a hearing device in accordance with an embodiment of the present invention.

### DETAILED DESCRIPTION

An exemplary embodiment of the present invention provides a stand-alone microphone test device and method that is easy to use and economical. The stand-alone test may be used by patients who wear a hearing device and other non-medical personnel without extensive training or expertise.

In some current systems, a user may be provided with an indication on an LED or LCD that there is sound being produced, but the internal diagnostics are inadequate to determine the quality of the microphone. A technician or other individual may listen to an attached earphone to judge the quality of the speech processor, but may not be able to determine the quality or condition of the microphone, without using an auxiliary testing system. A technician or clinician may utilize a separate commercial-off-the-shelf (COTS) microphone test system, such as a FONIX™ box, to measure the quality of a microphone.

According to an embodiment of the present invention, a user may perform a microphone test on a hearing device, such as a behind-the-ear (BTE) device, using, for example, attachable earphones as a sound source. Both the hearing device and at least one earphone may be placed in a mold, or other position orienting device, to keep the earphone in a fixed position relative to the microphone to perform a test. Preferably, the fixed position created by the mold may also eliminate or reduce the ambient noise.

In an embodiment of the present invention, a hearing device contains a digital signal processor (DSP) that may use maximum length sequence (MLS) based techniques to measure the impulse response of the system. This measured impulse response may be compared with a reference signal, by which the quality of the microphones may be judged. In embodiments of the present invention, a visual indication may be used to indicate the quality of the microphones on an LED or LCD. Furthermore, other analysis mechanisms may be utilized in conjunction with a stand-alone test system, such as a spectral analyzer or dynamic range analyzer, to increase the robustness of the test and/or presentation of test results.

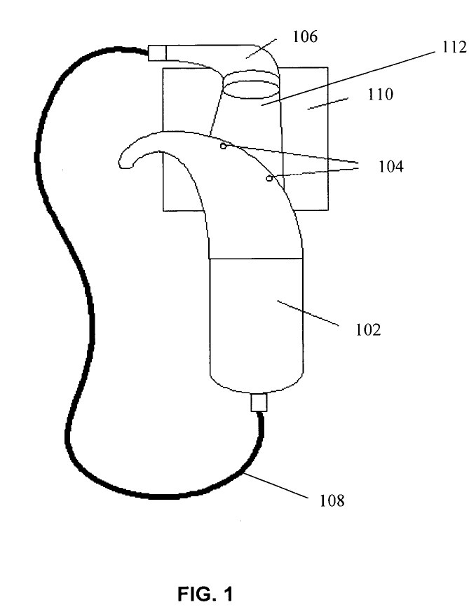

FIG. 1 shows a schematic view of a hearing device configured for a stand-alone microphone test in accordance with an embodiment of the present invention. Hearing device 102 contains two microphones 104. Although, two microphones are shown in FIG. 1, it should be appreciated that any suitable number of microphones may be utilized in such hearing devices, such as 1, 2, 3 or more than 3. Hearing device 102 is configured to communicate with attachable earphone 106 through wire 108. While a wire, such as wire 108, is shown in FIG. 1, it should be appreciated that wireless communication may also be utilized in embodiments of the present invention. Hearing device 102 and earphone 106 are shown in mold 110.

Mold 110 may be a partial enclosure, as shown in FIG. 1, or may completely enclose hearing device 102 and earphone 106, using either a unibody or multi-part mold. Mold 110 orients hearing device 102 and earphone 106 such that a repeatable distance and orientation may be achievable in successive tests. Mold 110 forms a sound channel 112 to direct sound from earphone 106 toward microphones 104. The arrangement of mold 110 and channel 112 helps to shield microphones 104 from external noises or sounds during the test.

The mold is preferably made of plastic, forming a snug fit over the speech processor. This plastic could be of ABS type, similar to the material a speech processor or hearing aid might be made from. Further, a type of rubber polymer such as Kraton could also line the ABS mold, so that when in contact with the speech processor (underside) and in contact with the earphones (top side) of the mold, a snug fit with acoustic sealing properties around the microphone ports is obtained. However, it will be appreciated that any suitable material may be employed.

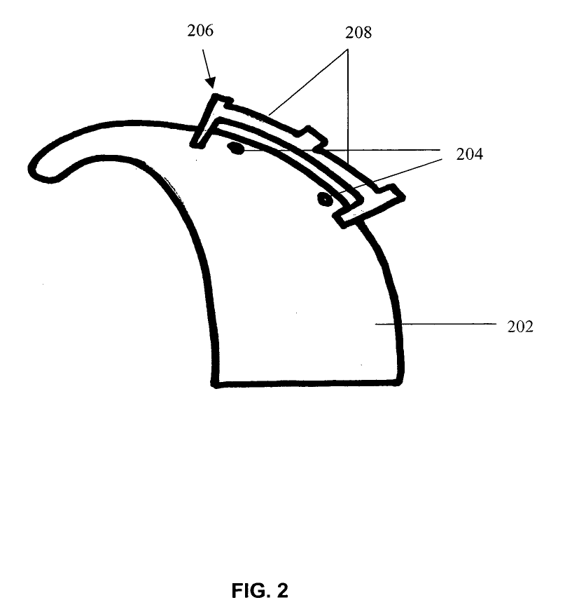

In an embodiment of the present invention as shown in FIG. 2, a schematic view of a hearing device 202 configured for a stand-alone microphone test is shown. Hearing device 202 contains two microphones 204. Although, two microphones are shown in FIG. 2, it should be appreciated that any suitable number of microphones may be utilized in such hearing devices, such as 1, 2, 3 or more than 3. Hearing device 202 is configured to removably connect to a housing in the form of mold 206. Mold 206 is constructed such that it may be connected to hearing device 202 in one location that provides a repeatable distance and orientation between microphone 204 and sound source (not shown). Mold 206 may attach to hearing device 202 by clips, tabs, snaps, hook-and-loop fasteners, adhesive, tension forces, etc. Mold 206 is shown with two receptacles 208 for holding or connecting to at least one sound source. Thus, mold 206 allows for independent testing of each of microphones 204, with one or more sound sources. However, it should be appreciated that mold 206 may be modified to provide only one receptacle and thus allow for testing of two microphones with one sound source. Mold 206 orients hearing device 202 and the sound source such that a repeatable distance and orientation may be utilized in successive tests. Mold 206 may be a partial enclosure, as shown in FIG. 2, or may completely enclose hearing device 202, using either a unibody or multi-part mold.

Suitable sound sources of the present invention include earphones, headphones, speakers, and any other sound producing mechanism now or later developed that may produce a sound or test signal, noise, sine, MLS noise, etc.

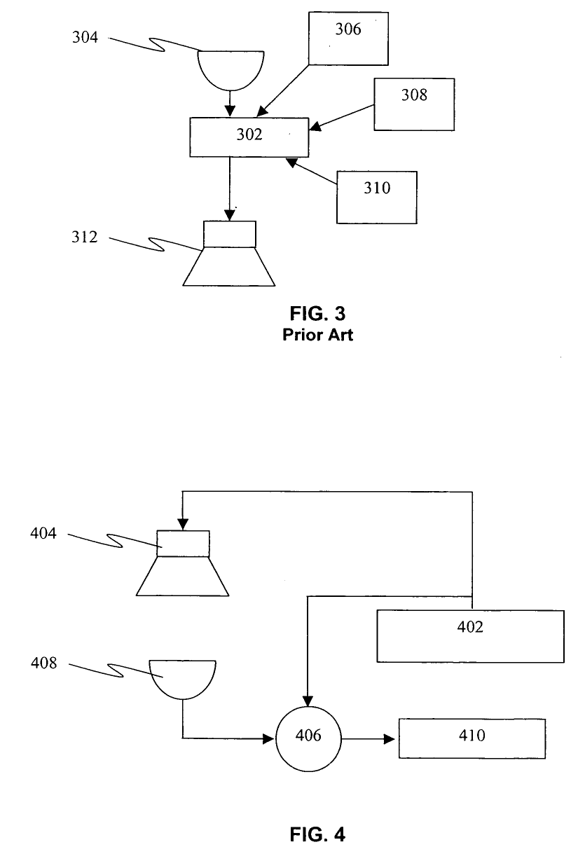

FIG. 3 shows a prior art method of testing a microphone. A master switch 302 is used as the controller for input from microphone 304 and external input 306. Master switch 302 also contains a test tone generator 308 and a memory 310. The sound is then output to receiver 312 and analyzed for quality.

According to an embodiment of the present invention, the impulse response of a standard system may be used as a reference response to compare a system under test. In FIG. 4, a hearing device contains a test signal/sequence output generator 402 that provides a sound signal to receiver 404 and a reference signal to a comparator 406. Microphone 408 receives Sound output from receiver 404 and transmits the signal to comparator 406. Comparator 406 compares the reference signal received from generator 402 with the signal received by microphone 408 and provides a test result 410. Test result 410 may be displayed in a visual and/or audible manner, with any suitable use of LEDs, LCDs and other similar indicators, singly or in combination.

According to an embodiment of the present invention, to check the quality of the microphone, it is useful to isolate the microphone response from the system response. Thus, the earphone response may be subtracted from the system response to obtain the microphone response:
Microphone Impulse=System Impulse−Earphone Impulse−Noise

The first condition for this comparison is that the earphone impulse response should be constant. The second condition for the comparison is that the measured impulse response should not be influenced by other sources such as external noise.

Several factors may have an impact on the constancy of the earphone response, such as variation between different sound sources and changing of the response of a particular sound source over time. If the variation between sound sources is determined to be a problem, a reference response per system may be measured during manufacture to lessen the impact. If the sound source fails, the system may be configured to indicate a system failure to avoid potentially faulty tests.

The measured impulse response may also be affected by other sources such as reflections (echos) from the environment and environmental noise.

To address the problems associated with external noise, an embodiment of the present invention may use a quasi-anechoic measurement method using maximum length sequence (MLS) signals, and cross-correlation of the input and the output to get the impulse response of the system.

An MLS based algorithmic measurement provides a cross-correlation method that may be used to compute the impulse response and reduce background noise so that measurements may be performed in relatively noisy environments. The use of averaging techniques further increases the S/N ratio. Furthermore, the measured distortion of the system may be spread throughout the computed impulse response.

In order for MLS to work accurately, the MLS signal length should be longer than the impulse response of the system under test or have the same length and the system under test should be time-invariant, at least during the measurement interval.

In embodiments of the present invention, an FFT may also be used to calculate the frequency response from the impulse response.

In an embodiment of the present invention, a hearing device may automatically detect that a mold or sound source has been connected to the hearing device. Thus, a hearing device may further be configured to automatically enter an accessory mode or testing mode. A TEST option or other menu option may be selected from an LCD to initiate a test. The LCD may provide an indication of the next step or steps to be performed, or there may be LEDs to indicate the step or steps to be performed. Either automatically or upon activation of a particular button or knob, a signal may be produced for the test. The DSP in the hearing device may measure the frequency and/or phase response using FFT or any other suitable mechanism now known or later developed. If the microphone response is within predefined parameters, an audible or visual indication may be provided to indicate the test was successful. Likewise, other audible or visual indicators may be provided to indicate a problematic condition, and to further distinguish the type and/or level of the problem. Auto-correct features may also be incorporated into the hearing device.

The present invention thus provides an inexpensive test system, utilizing existing and/or easily obtained components such as a sound source and an associated mold. A stand-alone test system may allow for quicker and easier analysis and thus may further reduce the number of processors returned for repair.

Although the present invention has been described with reference to an exemplary hearing device, any suitable components and/or configuration now or later known may be utilized in the present invention.

Although the present invention has been fully described in conjunction with the certain embodiments thereof with reference to the accompanying drawings, it is to be understood that various changes and modifications may be apparent to those skilled in the art.

1. A stand-alone microphone test device for a hearing device, said device including a housing adapted to receive a hearing device having at least one microphone, and a sound source operatively adapted to communicate with the hearing device, said housing operatively maintaining the sound source and said or each microphone in a predetermined relationship, so that operatively, when the sound source receives a signal from the hearing device, it produces an acoustic signal which is received by said or each microphone.

2. The test device according to claim 1, wherein the housing provides a sound channel to operatively direct sound from the sound source to the or each microphone.

3. The test device according to claim 2, wherein the housing at least partially encloses the sound source and the or each microphone.

4. The test device according to claim 3, wherein the sound source is detachable.

5. The test device according to claim 4, wherein the sound source is an earphone adapted to be connected to the hearing device.

6. The test device according to claim 5, wherein the sound source is integral with the housing.

7. The test device according to claim 2, for a hearing device having more than one microphone, wherein a separate sound source may be provided for each microphone.

8. A stand-alone microphone test system for a hearing device, said test system including a test device having a housing adapted to receive a hearing device having at least one microphone, and a sound source operatively adapted to communicate with the hearing device, said housing operatively maintaining the sound source and said or each microphone in a predetermined relationship, said hearing device further including a comparator and means for generating a test signal for transmission to said sound source, so that operatively, when the sound source receives a test signal from the hearing device, it produces an acoustic signal which is received by said or each microphone, said microphone detecting said signal and communicating a corresponding received signal to said comparator, said hearing device further sending a reference signal to said comparator, so that said received signal and said reference signal can be compared to determine the quality of the or each microphone.

9. The test system according to claim 8, wherein the test signal is a maximum length signal, and the comparator performs a cross correlation of the received signal and the reference signal to determine the impulse response of the system.

10. The test system according to claim 8, wherein the hearing device is a sound processor for a hearing implant, and the sound source is an earphone connected to said sound processor.

11. The test system according to claim 10, wherein the housing provides a sound channel to operatively direct sound from the sound source to the or each microphone.

12. The test system according to claim 11, wherein the housing at least partially encloses the sound source and the or each microphone.

13. A microphone test method for a hearing device, including the steps of: providing a housing adapted to receive a hearing device having at least one microphone, and a sound source operatively adapted to communicate with the hearing device;
Placing said hearing device into said housing;
Placing said hearing device into communication with said sound source
Generating a test signal in said hearing device and communicating said signal to said sound source, so that said sound source generates an acoustic signal;
receiving said acoustic signal from the sound source using said or each microphone,
processing the received acoustic signal to determine the quality of the or each microphone.

14. The method according to claim 13, wherein the housing provides a sound channel between the sound source and the or each microphone.

15. The A method according to claim 13, wherein the hearing device further includes a comparator and means for generating a reference signal and communicating said reference signal to said comparator, said comparator comparing said received signal and said reference signal to determine the quality of the or each microphone.

16. The method according to claim 15, wherein the test signal is a maximum length signal, and the comparator performs a cross correlation of the received signal and the reference signal to determine the impulse response of the system.
